(19) United States
(12) Patent Application Publication
(10) Pub. No.: US 2010/0091001 A1
(43) Pub. Date: Apr. 15, 2010

(54) Pixel and organic light emitting display device using the same

(75) Inventors: Do-Ik Kim, Suwon-si (KR); Wang-Jo Lee, Suwon-si (KR)

Correspondence Address: ROBERT E. BUSHNELL & LAW FIRM, 2029 K STREET NW, SUITE 600, WASHINGTON, DC, 20006-1004, US

(73) Assignee: SAMSUNG Mobile Display CO., LTD, Yongin-City (KR)

(21) Appl. No.: 12/585,617

(22) Filed: Sep. 18, 2009

(30) Foreign Application Priority Data
Oct. 13, 2008 (KR) 10-2008-0100085

(51) Int. Cl. G09G 5/00; G09G 3/30

(52) U.S. Cl. 345/211; 345/76

(57) ABSTRACT

A pixel capable of preventing abnormal light emission thereof. A pixel includes an organic light emitting diode coupled between a first power source and a second power source; a pixel circuit unit having a driving transistor coupled between the first power source and the organic light emitting diode to supply driving current to the organic light emitting diode during a light emitting period; and a bypass unit coupled between the pixel circuit unit and a bias power source, the bypass unit being turned on during a non-light emitting period in which the driving transistor is turned off.

### CLAIM OF PRIORITY

This application makes reference to, incorporates the same herein, and claims all benefits accruing under 35 U.S.C.§119 from an application for PIXEL AND ORGANIC LIGHT EMITTING DISPLAY DEVICE USING THE SAME earlier filed in the Korean Intellectual Property Office on 13 Oct. 2008 and there duly assigned Serial No. 10-2008-0100085.

### BACK OF THE INVENTION

1. Field of the Invention

The present invention relates to a pixel and an organic light emitting display device using the same, and more particularly, to a pixel capable of preventing abnormal light emission, and an organic light emitting display device using the same.

2. Description of Related Art

An organic light emitting display device is a kind of flat panel display device which displays images using organic light emitting diodes that emit light through the recombination of electrons and holes. The organic light emitting display device has a fast response speed and is driven with low power consumption.

Organic light emitting display devices are divided into a passive matrix type organic light emitting display device (PMOLED) and an active matrix type organic light emitting display device (AMOLED) depending on a method of driving an organic light emitting diode. The AMOLED is used in a portable display device and the like because of its low power consumption.

Each pixel of a conventional AMOLED includes an organic light emitting diode generating light corresponding to an amount of current supplied to its own pixel; a switching transistor supplying a data signal into the pixel when a scan signal is supplied; a storage capacitor storing the data signal from the switching transistor; and a driving transistor supplying driving current corresponding to the data signal stored in the storage capacitor to the organic light emitting diode.

An ideal pixel does not emit light while cutting off the flow of current in the pixel, when a data signal that expresses a black gray scale is supplied. However, an actual pixel emits dim light due to the leakage current generated from a driving transistor or the like, when a data signal that expresses a black gray scale is supplied. As such, when a pixel emits light due to the leakage current, a contrast ratio is degraded.

### SUMMARY OF THE INVENTION

Accordingly, it is an object of the present invention to provide a pixel capable of preventing abnormal light emission due to leakage current, and an organic light emitting display device using the same.

According to an aspect of the present invention, there is provided a pixel including an organic light emitting diode coupled between a first power source and a second power source; a pixel circuit unit having a driving transistor coupled between the first power source and the organic light emitting diode to supply driving current to the organic light emitting diode during a light emitting period; and a bypass unit coupled between the pixel circuit unit and a bias power source, the bypass unit being turned on during a non-light emitting period in which the driving transistor is turned off.

According to another aspect of the present invention, there is provided an organic light emitting display device, including a pixel unit having a plurality of pixels formed at intersection areas of scan and data lines and receiving a first power source, a second power source and a bias power source from an outside of the organic light emitting display device; a scan driving unit supplying a scan signal to the scan lines; and a data driving unit supplying data signals to the data lines, wherein each of the pixels comprises: an organic light emitting diode coupled between a first power source and a second power source; a pixel circuit unit having a driving transistor coupled between the first power source and the organic light emitting diode to supply driving current to the organic light emitting diode during a light emitting period; and a bypass unit coupled between the pixel circuit unit and a bias power source, the bypass unit being turned on during a non-light emitting period in which the driving transistor is turned off.

According to the present invention, a bypass transistor is provided to bypass leakage current in a pixel, thereby preventing abnormal light emission of the pixel.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram schematically showing the configuration of an organic light emitting display device according to an embodiment of the present invention;

FIG. 2 illustrates a frame according to the embodiment of the present invention;

FIG. 3 is a circuit diagram of a pixel according to an embodiment of the present invention;

FIG. 4 is a graph showing voltage-current characteristics; and

FIG. 5 is a circuit diagram of a pixel according to another embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

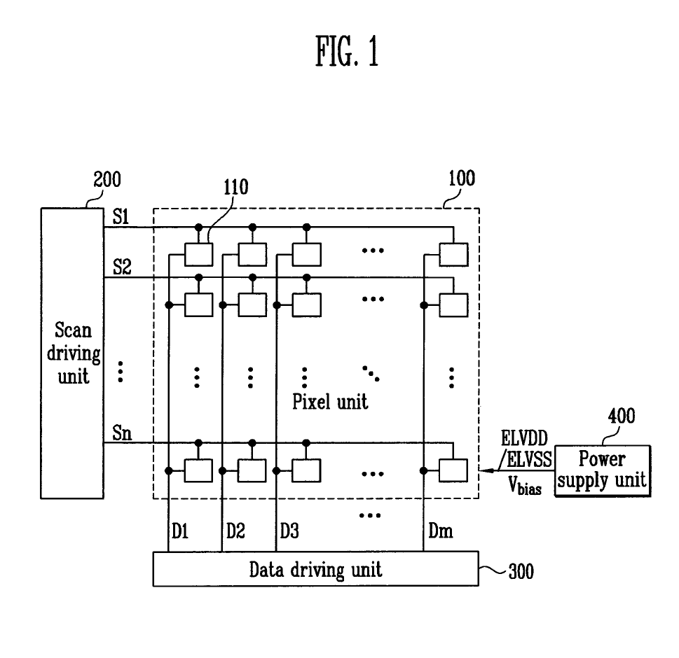

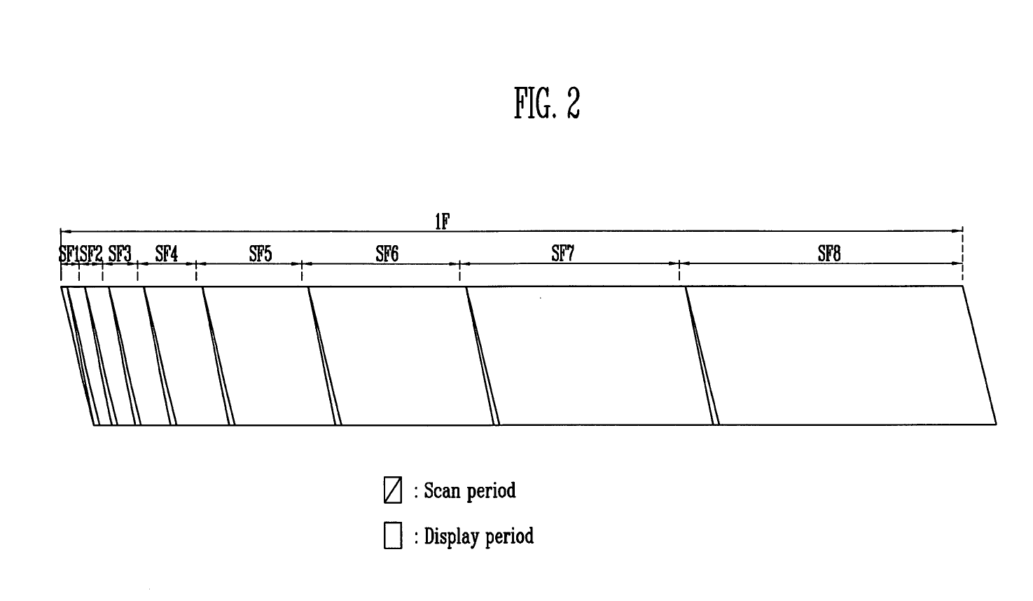

FIG. 1 is a block diagram schematically showing the configuration of an organic light emitting display device according to an embodiment of the present invention. FIG. 2 shows a frame according to the embodiment of the present invention.

Referring to FIG. 1, the organic light emitting display device includes a pixel unit 100, a scan driving unit 200, a data driving unit 300 and a power supply unit 400.

The pixel unit 100 includes a plurality of pixels 110 formed at intersection areas of scan lines S1 to Sn and data lines D1 to Dm. The pixel unit 100 is driven by receiving a first power source ELVDD, a second power source ELVSS and a bias power source V_{bias} supplied from the power supply unit 400.

The scan driving unit 200 sequentially supplies a scan signal to the scan lines S1 to Sn in response to a scan control signal supplied from the outside of the organic light emitting display device.

When the organic light emitting display device is driven by a digital driving method shown in FIG. 2, the scan driving unit 200 supplies a scan signal to the scan lines S1 to Sn during a scan period of each sub-frame SF. The digital driving method of an organic light emitting display device is a driving method of expressing luminance by dividing one frame 1F into a plurality of sub-frames SFs and setting display periods for the respective sub-frames SFs to be different.

When a scan signal is supplied to the scan lines S1 to Sn, pixels 110 are selected for each line, and the selected pixels 110 receive data signals from the data lines D1 to Dm.

The data driving unit 300 supplies data signals to the data lines D1 to Dm in response to data and a data control signal. Then, the data signals are supplied to the pixels 110 selected by the scan signal.

When the organic light emitting display device is driven by a digital driving method, the data driving unit 300 supplies first and second data signals to the data lines D1 to Dm as data signals. Here, the first data signal allows the pixels 110 to emit light, and the second data signal allows the pixels 110 not to emit light. The first and second data signals have opposite voltage levels.

For example, when the first data signal is set as a low level, the second data signal is set as a high level. That is, the data driving unit 300 supplies two types of data signals, i.e., high and low levels, to the data lines D1 to Dm during a display period of each of the sub-frames SFs.

Then, pixels 110 receiving the first data signal emit light during a predetermined period (a display period of each of the sub-frames SFs), and pixels 110 receiving the second data signal supplied from the data driving unit 300 do not emit light, thereby displaying an image having a predetermined luminance.

The power supply unit 400 supplies a first power source ELVDD, a second power source ELVSS and a bias power source V_{bias} to the pixel unit 100. Here, the first power source ELVDD is a high-potential pixel power source, and the second power source ELVSS is a low-potential pixel power source having a lower potential than that of the first power source ELVDD. The bias power source V_{bias} may be set as a power source having the same potential as that of the second power source ELVSS. Alternatively, the bias power source V_{bias} may be set as a separate power source having a lower potential than that of the second power source ELVSS.

In the organic light emitting display device each of the pixels 110 has a bypass transistor (not shown) to bypass internal leakage current generated when each of the pixels 110 does not emit light. Accordingly, it is possible to prevent abnormal light emission of the pixels 110, which will be described in detail later.

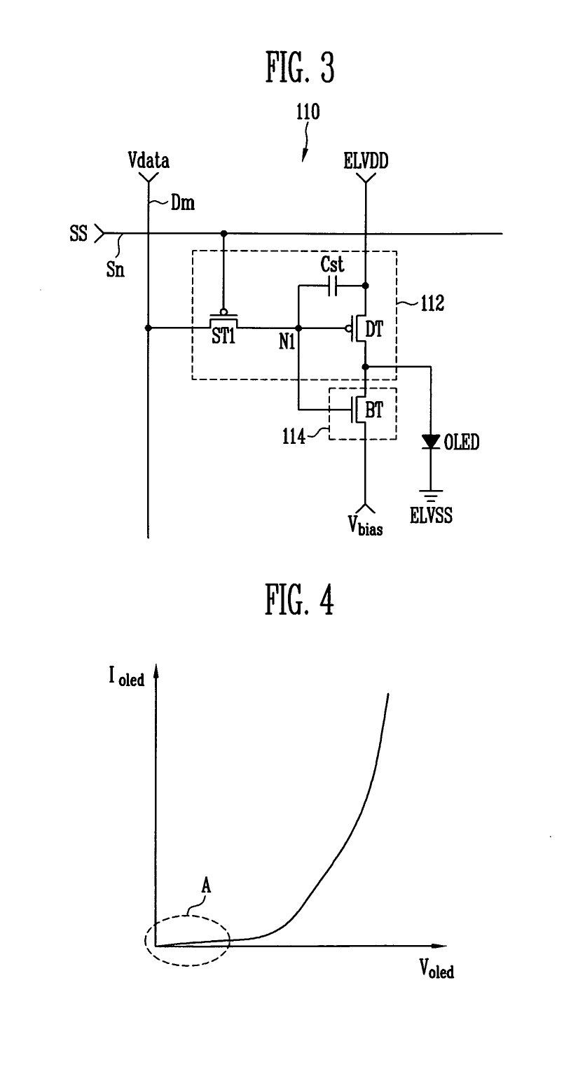

FIG. 3 is a circuit diagram of a pixel according to an embodiment of the present invention. For convenience of illustration, FIG. 3 shows a pixel positioned at an n-th row and an m-th column. The pixel of FIG. 3 may be applied to the organic light emitting display device shown in FIG. 1.

Referring to FIG. 3, the pixel 110 includes an organic light emitting diode OLED coupled between first and second power sources ELVDD and ELVSS; a pixel circuit unit 112 coupled between the first power source ELVDD and the organic light emitting diode OLED to supply a driving current to the organic light emitting diode OLED; and a bypass unit 114 coupled between the pixel circuit unit 112 and a bias power source V_{bias} to bypass leakage current generated from the pixel 110.

More specifically, an anode electrode of the organic light emitting diode OLED is coupled to the pixel circuit unit 112, and a cathode electrode of the organic light emitting diode OLED is coupled to the second power source ELVSS. The organic light emitting diode OLED emits light in response to current supplied from the pixel circuit unit 112.

The pixel circuit unit 112 includes a driving transistor DT, a switching transistor ST1 and a storage capacitor Cst.

The driving transistor DT is coupled between the first power source ELVDD and the anode of the organic light emitting diode OLED, and a gate electrode of the driving transistor DT is coupled to a first node N1. A storage capacitor Cst is coupled between the first node N1 and the first power source ELVDD. The driving transistor DT supplies driving current to the organic light emitting diode OLED in response to a voltage at the first node N1. A gate electrode of the bypass transistor BT is also coupled to the first node N1.

In the pixel driven by the digital driving method, the driving transistor DT supplies or does not supply driving current to the organic light emitting diode OLED in response to a low-level or high-level data signal Vdata supplied during a period of each of the sub-frames SFs. Here, the low-level data signal Vdata (a first data signal) is set as a voltage level capable of allowing the driving transistor DT to be turned on and allowing the bypass transistor BT to be turned off The high-level data signal Vdata (a second data signal) is set as a voltage level capable of allowing the driving transistor DT to be turned off and allowing the bypass transistor BT to be turned on.

For example, when the low-level data signal Vdata is supplied to the first node N1 through a data line Dm, the driving transistor DT is turned on and supplies driving current to the organic light emitting diode OLED. When the high-level data signal Vdata is supplied to the first node through the data line Dm, the driving transistor DT is turned off and does not supply driving current to the organic light emitting diode OLED.

Hereinafter, the display period in which the organic light emitting diode OLED is turned on is referred to as a “light emitting period,” and the period in which the driving transistor DT is turned off is referred to as a “non-light emitting period.”

That is, when the first data signal (low-level data signal) is supplied in a corresponding sub-frame SF, the driving current is supplied to the organic light emitting diode OLED by the turned-on driving transistor DT so that the organic light emitting diode OLED emits light. When the second data signal (high-level data signal) is supplied in the corresponding sub-frame SF, the driving current is not supplied to the organic light emitting diode OLED by the turned-off driving transistor DT so that the organic light emitting diode OLED does not emit light.

The switching transistor ST1 is coupled between the first node N1 and the data line Dm, and a gate electrode of the switching transistor ST1 is coupled to a scan line Sn. When a scan signal SS is supplied to the switching transistor ST1 through the scan line Sn, the switching transistor ST1 is turned on to transfer the data signal Vdata supplied from the data line Dm to the first node N1.

The storage capacitor Cst is coupled between the first node N1 and the first power source ELVDD. Here, when the data signal Vdata is supplied to the first node N1, a voltage corresponding to the data signal Vdata is charged into the storage capacitor Cst. That is, when the organic light emitting display device is driven by a digital driving method, the data signal Vdata supplied for each of the sub-frames SFs is charged into the storage capacitor Cst, and the storage capacitor Cst maintains the voltage at the first node N1 during a corresponding sub-frame SF.

The bypass unit 114 is coupled between the pixel circuit unit 112 and the bias power source V_{bias}. The bypass unit 114 includes a bypass transistor BT which may coupled in parallel with the organic light emitting diode OLED when the second power source ELVSS and the bias power source V_{bias} are identical. In order to bypass leakage current to the bias power source V_{bias}, the potential of the bias power source V_{bias} may be set lower than that of the second power source ELVSS.

More specifically, the bypass transistor BT is coupled between the driving transistor DT and the bias power source V_{bias}. The bypass transistor BT is turned on during the non-light emitting period in which the driving transistor DT is turned off, to bypass leakage current generated in the pixel 110 to the bias power source V_{bias}.

To this end, in this embodiment, a gate electrode of the bypass transistor BT is coupled to the first node N1 coupled to the gate electrode of the driving transistor DT, but the bypass transistor BT and the driving transistor DT are set as opposite types of transistors. For example, when the driving transistor DT is set as a p-type transistor, the bypass transistor BT is set as an n-type transistor.

Accordingly, when the organic light emitting display device is driven by a digital driving method, the bypass transistor BT is turned off during the light emitting period in which the first data signal is supplied, and the bypass transistor BT is turned on during the non-light emitting period in which the second data signal is supplied. As such, when the bypass transistor BT is turned on during the non-light emitting period, leakage current is bypassed through the bypass transistor BT, so that the leakage current does not flow through the organic light emitting diode OLED. Here, the leakage current may be generated related to characteristics of the driving transistor DT, a crosstalk or a charge discharge of the storage capacitor Cst. Accordingly, it is possible to prevent abnormal light emission of the organic light emitting diode OLED during the non-light emitting period.

The operation of the aforementioned pixel 110 will now be described. When a scan signal SS is supplied to the switching transistor ST1 through the scan line Sn, the switching transistor ST1 is first turned on. Then, a data signal Vdata supplied from the data line Dm to the first node N1. At this time, a voltage corresponding to the data signal Vdata is charged into the storage capacitor Cst.

When the data signal Vdata is a low-level first data signal, the driving transistor is turned on and the bypass transistor BT is turned off. Accordingly, driving current flows between the first power source ELVDD and the second power source ELVSS via the driving transistor DT and the organic light emitting diode OLED, so that the organic light emitting diode OLED emits light.

When the data signal Vdata is a high-level second data signal, the driving transistor DT is turned off and the bypass transistor BT is turned on. Then, driving current is not supplied from the driving transistor DT to the organic light emitting diode OLED, and leakage current which may be generated from the driving' transistor DT is bypassed to the bias power source V_{bias} through the bypass transistor BT.

When leakage current occurs from the driving transistor DT, a voltage V_{oled} to the organic light emitting diode OLED is determined by a ratio of off-resistance of the driving transistor DT to on-resistance of the bypass transistor BT. Although characteristics of the driving transistor DT are not excellent as a resistance ratio of 100:1 or so, a low voltage of below a few tens of mV is applied to the organic light emitting diode OLED.

Here, a very low current I_{oled} close to zero flows through the organic light emitting diode OLED in an area where a low voltage V_{oled} is applied the organic light emitting diode OLED as shown in area A of FIG. 4. Therefore, current hardly flows through the organic light emitting diode OLED at a low voltage V_{led}. Accordingly, a non-light emitting state is maintained in the organic light emitting diode OLED by the turned-on bypass transistor BT during the non-light emitting period.

In order to bypass leakage current to the bias power source V_{bias}, the potential of the bias power source V_{bias} may be set lower than that of the second power source ELVSS.

When the potential of the bias power source V_{bias} is identical to that of the second power source ELVSS, the second power source ELVSS may be used as the bias power source V_{bias} without supplying a separate power source. At this time, the voltage difference between the anode and cathode electrodes of the organic light emitting diode OLED becomes zero during the non-light emitting period. Therefore, an off-state is maintained in the organic light emitting diode OLED.

When the potential of the bias power source V_{bias} is lower than that of the second power source ELVSS, a reverse voltage is applied to the organic light emitting diode OLED during the non-light emitting period. Therefore, the lifespan of the organic light emitting diode OLED is extended.

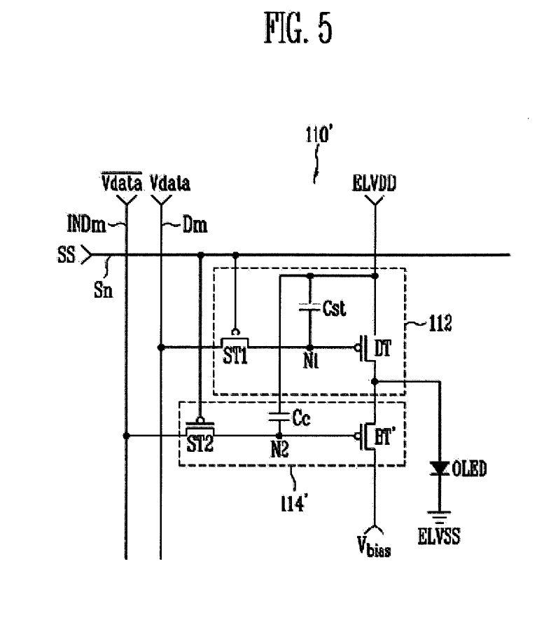

FIG. 5 is a circuit diagram of a pixel according to another embodiment of the present invention. In FIG. 5, elements identical to those of FIG. 3 are designated by same reference numerals, and their detailed descriptions will be omitted.

Referring to FIG. 5, the pixel 110′ is further coupled to an inverted data line INDm through which an inverted data signal V̅d̅a̅t̅a̅ is supplied. In this case, in the organic light emitting display device of FIG. 1, an inverted data line INDm may be further added to each channel of the data driving unit 300 corresponding to a data line Dm. Alternatively, a separate circuit may be provided between the data driving unit 300 and the pixel unit 100 or in the pixel unit 100. Here, the separate circuit inverts data signals and supplied them to the pixels 110.

Like the bypass transistor BT of FIG. 3, a bypass transistor BT′ may be coupled in parallel with an organic light emitting diode OLED between a driving transistor DT and a bias power source V_{bias}, an when the second power source ELVSS and the bias power source V_{bias} are identical. A gate electrode of the bypass transistor BT′ is coupled to a second node N2.

A bypass unit 114′ includes bypass transistor BT′, second node N2 and further includes a switching transistor ST2 and a control capacitor Cc. The switching transistor ST2 is coupled between the inverted data line INDm and the second node N2, and a gate electrode of the switching transistor ST2 is coupled to a scan line Sn. The control capacitor Cc is coupled between the second node N2 and first power source ELVDD.

When a scan signal SS is supplied to the scan line Sn, the switching transistor ST2 is turned on to supply the inverted data signal V̅d̅a̅t̅a̅ supplied through the inverted data line INDm to the second node N2. At this time, a voltage corresponding to the inverted data signal V̅d̅a̅t̅a̅ is charged into the control capacitor Cc.

The operation of the aforementioned pixel 110′ will now be described. When a scan signal SS is supplied to the scan line Sn, the first and second transistors ST1 and ST2 are first turned on. Then, a data signal Vdata supplied through the data line Dm is supplied to a first node N1, and an inverted data signal V̅d̅a̅t̅a̅ supplied through the inverted data line INDm is supplied to the second node N2. At this time, a voltage corresponding to the data signal Vdata is charged into a storage capacitor Cst, and a voltage corresponding to the inverted data signal V̅d̅a̅t̅a̅ is charged into the control capacitor Cc.

When the data signal Vdata is a low-level first data signal and the inverted data signal V̅d̅a̅t̅a̅ is a high-level second data signal, the driving transistor DT is turned on, and the bypass transistor BT′ is turned off. Accordingly, driving current flows from the first power source ELVDD to a second power source ELVSS via the driving transistor DT and the organic light emitting diode OLED, so that the organic light emitting diode OLED emits light.

When the data signal Vdata is a high-level second data signal and the inverted data signal V̅d̅a̅t̅a̅ is a low-level second data signal, the driving transistor DT is turned off, and the bypass transistor BT′ is turned on. Then, driving current is not supplied from the driving transistor DT to the organic light emitting diode OLED, and leakage current which may be generated from the driving transistor DT is bypassed to the bias power source V_{bias} through the bypass transistor BT. Accordingly, a non-light emitting state is maintained in the organic light emitting diode OLED by the turned-on bypass transistor BT during the non-light emitting period.

Meanwhile, in this embodiment, the driving transistor DT, the bypass transistor BT′ and the first and second switching transistors ST1 and ST2 are all set as the same type of transistors. For example, the driving transistor DT, the bypass transistor BT′ and the first and second switching transistors ST1 and ST2 may all be set as p-type transistors. Accordingly, a process of forming the pixel 110′ can be simplified not by using a CMOS process but by using a relatively small number of masks.

Although the transistors of the pixel 110′ in FIG. 5 are all set as p-type transistors, the present invention is not limited thereto. For example, it will be apparent that the present invention may be implemented by setting all the transistors in the pixel 110′ as n-type transistors and modifying a circuit configuration to be suitable for the n-type transistors.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A pixel, comprising:
an organic light emitting diode coupled between a first power source and a second power source;
a pixel circuit unit having a driving transistor coupled between the first power source and the organic light emitting diode to supply driving current to the organic light emitting diode during a light emitting period; and
a bypass unit having a bypass transistor coupled between the pixel circuit unit and a bias power source, the bypass transistor being turned on during a non-light emitting period in which the driving transistor is turned off.

2. The pixel as claimed in claim 1, wherein the bypass transistor and the driving transistor are set as opposite types of transistors having gate electrodes coupled to a common node.

3. The pixel as claimed in claim 1, wherein the pixel circuit unit further comprises:
a first switching transistor coupled between a first node and a data line, the first switching transistor having a gate electrode coupled to a scan line, the first node being coupled to a gate electrode of the driving transistor and the data line through which a data signal is supplied via the first switching transistor; and
a storage capacitor coupled between the first node and the first power source.

4. The pixel as claimed in claim 3, wherein the bypass unit further comprises:
a second switching transistor coupled between a second node and an inverted data line, the second switching transistor having a gate electrode coupled to the scan line, the second node being coupled to a gate electrode of the bypass transistor and the inverted data line through which an inverted data signal is supplied via the second switching transistor; and
a control capacitor coupled between the second node and the first power source.

5. The pixel as claimed in claim 4, wherein the bypass transistor, the driving transistor and the first and second switching transistors are all set as the same type of transistors.

6. The pixel as claimed in claim 4, wherein each of the data signal and the inverted data signal is supplied as a low or high level.

7. The pixel as claimed in claim 1, wherein the pixel is digitally driven by receiving a low-level or high-level first or second data signal supplied during each of a plurality of sub-frames constituting one frame.

8. The pixel as claimed in claim 1, wherein the first and second power sources are set as high-potential and low-potential pixel power sources, respectively, and the potential of the bias power source is set lower than that of the second power source.

9. The pixel as claimed in claim 1, wherein the first and second power sources are set as high-potential and low-potential pixel power sources, respectively, and the potential of the bias power source is identical to that of the second power source.

10. An organic light emitting display device, comprising:
a pixel unit having a plurality of pixels formed at intersection areas of scan and data lines and receiving a first power source, a second power source and a bias power source from an outside of the organic light emitting display device;
a scan driving unit supplying a scan signal to the scan lines; and
a data driving unit supplying data signals to the data lines,
each of the pixels comprising:
an organic light emitting diode coupled between a first power source and a second power source;
a pixel circuit unit having a driving transistor coupled between the first power source and the organic light emitting diode to supply driving current to the organic light emitting diode during a light emitting period; and
a bypass unit having a bypass transistor coupled between the pixel circuit unit and a bias power source, the bypass transistor being turned on during a non-light emitting period in which the driving transistor is turned off.

11. The organic light emitting display device as claimed in claim 10, wherein the bypass transistor and the driving transistor are set as opposite types of transistors having gate electrodes coupled to a same node.

12. The organic light emitting display device as claimed in claim 10, wherein the pixel circuit unit further comprises:
a first switching transistor coupled between a first node and a data line, the first switching transistor having a gate electrode coupled to a corresponding scan line, the first node being coupled to the gate electrode of the driving transistor, and the first node being coupled to a corresponding data line through which a data signal is supplied via the first switching transistor; and
a storage capacitor coupled between the first node and the first power source.

13. The organic light emitting display device as claimed in claim 12, wherein each of the pixels is further coupled to a corresponding inverted data line through which an inverted data signal is supplied.

14. The organic light emitting display device as claimed in claim 13, wherein the bypass unit further comprises:
a second switching transistor coupled between a second node and the corresponding inverted data line, the second switching transistor having a gate electrode coupled to the corresponding scan line, the second node being coupled to a gate electrode of the bypass transistor, and the second node being coupled to the corresponding inverted data line through which the inverted data signal is supplied via the second switching transistor; and
a control capacitor coupled between the second node and the first power source.

15. The organic light emitting display device as claimed in claim 14, wherein the bypass transistor, the driving transistor and the first and second switching transistors are all set as the same type of transistors.

16. The organic light emitting display device as claimed in claim 10, wherein one frame is divided into a plurality of sub-frames, the scan driving unit supplies the scan signal to the scan lines for each of the sub-frames, and the data driving unit supplies first and second data signals to the data lines for each of the sub-frames.

17. The organic light emitting display device as claimed in claim 16, wherein the first data signal is set as a voltage level at which the driving transistor is turned on, the second data signal is set as a voltage level at which the bypass transistor is turned on.

18. The organic light emitting display device as claimed in claim 10, wherein the first and second power sources are set as high-potential and low-potential pixel power sources, respectively, and the potential of the bias power source is set lower than that of the second power source.

19. The organic light emitting display device as claimed in claim 10, wherein the bias power source is identical to the second power source.
